(19) United States
(12) Patent Application Publication
(10) Pub. No.: US 2026/0285627 A1
(43) Pub. Date: Sep. 24, 2026

(54) METHOD FOR HANDLING SHEETS BY A DIE CUTTING MACHINE AND A DIE CUTTING MACHINE

(71) Applicant: BOBST MEX SA, Mex (CH)

(72) Inventors: Patrice CHATRY, Lugrin (FR); Michel ROD, Semsales (CH)

(73) Assignee: BOBST MEX SA, Mex (CH)

(21) Appl. No.: 19/480,112

(22) PCT Filed: Apr. 19, 2024
(86) PCT No.: PCT/EP2024/060669

§ 371 Date: Oct. 30, 2025

(30) Foreign Application Priority Data
May 2, 2023 (EP) 23171054.2

(51) Int. Cl. B65H 3/08; B26D 7/32; B65H 11/00; B65H 35/00

(52) U.S. Cl. CPC B65H 3/0816; B26D 7/325; B65H 11/007; B65H 35/0073; B65H 2801/42

(57) ABSTRACT

The present invention generally relates to a method for handling sheets by a die-cutting machine having a platen press with a cutting device. Using a lifting device, a first sheet and a second sheet are separated from a plurality of sheets and fed to the platen press. Using an alignment device, the first and the second sheet are aligned such that they reach a reception location simultaneously, in register, and stacked. Using a gripper bar, the stacked sheets are captured at the reception location and transported to the cutting device of the platen press. Since the sheets are stacked, they are cut simultaneously in a single cutting operation.

### FIELD OF THE DISCLOSURE

The present invention generally relates to a method for handling sheets by a die cutting machine and a die cutting machine.

### BACKGROUND

In platen presses of die cutting machines sheets are handled and processed, such as e.g. being cut. To achieve the desired quality of the finished product, an alignment of the processed sheet is required with respect to the processing device of the platen press. This alignment has to be separately achieved and maintained for every separate sheet during the entire production procedure. For Example, WO 2017/202498 A1 discloses a system that grabs a sheet on the fly in the introduction station to bring it precisely to the platen press according to the position of printed marks on the sheet. The system works one sheet at a time. As a consequence, the production efficiency of the platen press and the entire die cutting machine is limited.

Accordingly, there is need for providing a die cutting machine which can be processed such that the disadvantages of the prior art may be avoided or at least be reduced.

### SUMMARY

The subject matter of the independent claims satisfy the respective need. Preferred embodiments are indicated within the dependent claims and the following description, each of which, individually or in combination, may represent aspects of the disclosure. Some aspects are explained with respect to devices, others with respect to methods. However, the aspects are to be correspondingly transferred.

A summary of certain embodiments disclosed herein is set forth below. It should be understood that these aspects are presented merely to provide a brief summary of these certain embodiments and that these aspects are not intended to limit the scope of this disclosure. This disclosure may encompass a variety of aspects that may not be set forth below.

According to an aspect, a method for handling sheets by a die cutting machine having a platen press is provided. The method comprises at least the following steps:

A first sheet to be fed to the platen press is separated from a plurality of sheets to be fed using a lifting device (step A).

A second sheet to be fed to the platen press is separated from the plurality of sheets to be fed using a lifting device (step B).

The first and the second sheet to be fed to the platen press are aligned such that they reach a reception location simultaneously and in register with each other in a stacked fashion using an alignment device (step C).

The stacked first and second sheet to be fed are captured at the reception location using at least one gripper bar (step D).

The stacked first and second sheet are transported to a cutting device of the platen press using the at least one gripper bar (step E).

The stacked first and second sheet are simultaneously cut in a single cutting operation using the cutting device (step F).

Within the present context, being in register with each other in a stacked fashion refers to two sheets which have same dimensions and which are stacked and aligned such that their side surfaces which are oriented perpendicular to the extending top and bottom surfaces fall in line with each other.

Within the present context, the cutting device may be considered a device which is configured to produce cutouts from the stacked sheets. The cutting device may also comprise a stamping device which simultaneously stamps both sheets with respect to a rest on which the sheets are placed. The cutting device is part of the platen press which itself is part of the die cutting machine.

The present method allows to advantageously improve the production rate of the sheets treated by the platen press as two sheets are simultaneously processed. Hence, the production efficiency of the die cutting machine is improved as well. However, in view of the alignment device the alignment of both sheets is guaranteed. Therefore, the quality of the processed sheets is maintained independent from the simultaneous processing of two sheets. As a consequence, a given number of sheets can be handled in a shorter time period.

Preferably, cut blanks are separated from the stacked first and second sheet simultaneously in a single separating operation subsequent to step F. Thereby, the production efficiency is further improved since for prior art methods the blanks of the independently processed sheets are subsequently separated. These individual separating procedures may be avoided for the present method.

Optionally, the first sheet to be fed is transported towards the reception location using a first transport velocity in step C, the second sheet to be fed is transported towards the reception location using a second transport velocity in step C, and the first and the second transport velocities are adjusted to each other such that the first and the second sheet to be fed reach the reception location simultaneously and in register with each other in a stacked fashion. Therefore, the time difference which is caused by the points in time, when the individual sheets are independently separated from the plurality of sheets may be compensated by the different transport velocities. Hence, the different transport velocities guarantee that the sheets reach the reception location simultaneously. In essence, the separate lifting devices used for lifting the separate sheets in this embodiment may move at different speeds.

Optionally, the transport velocities may even be adjusted to each other during the transport procedure towards the reception location. Thus, unexpected relative distances between the sheets may be compensated. In this regard, for example at least one sensor device may be used to acquire a relative distance between the sheets based on which it may be determinable whether any transport velocity is required to be adapted during the transport procedure.

In some embodiments, the first and second transport velocities are varied during a transport procedure of the first and second sheet towards the reception location in step C and the first and second transport velocities are adjusted to each other such that they are same when the first and the second sheet to be fed reach the reception location. Accordingly, it may be guaranteed that the velocity of sheets are same at the reception location. Therefore, from the reception location on, the sheets may be transported with same velocities in a stacked package.

Preferably, in step C the first and the second sheet to be fed are carried using a lifting device until they are aligned to each other.

In particular, for each sheet to be handled, the lifting device may first be used to separate the sheet from the plurality of sheets and subsequently be used to transport the respective sheet to the reception location. The velocity of the lifting device may then be adapted appropriately.

In some embodiments, the first and the second sheet to be fed are carried using a conveyor mechanism in step C. A breaking mechanism is provided at the reception location. The breaking mechanism is released as soon as the first and the second sheet reach the breaking mechanism in register with each other in a stacked fashion. Accordingly, the alignment of the sheets to be handled and stacked with each other may even be simplified from a controlling point of view. The breaking mechanism may guarantee specific velocities of the sheets at the reception location. After releasing the sheets, both sheets may comprise a same velocity. In other words, the breaking mechanism assists in adapting the relative velocities of the sheets with respect to each other.

Preferably, the first and the second sheet are carried in an at least partially stacked fashion towards the reception location in step C. The breaking mechanism provides the possibility to simultaneously adapt velocities of the individual sheets so that they comprise same velocities when they reach the breaking mechanism. Therefore, the sheets may also be at least partially stacked with each other prior to reaching the breaking mechanism as the velocity adaption is independent therefrom. Consequently, the time difference required between subsequent stacking actions may be shortened. Thereby, the production rate of the method is improved.

Optionally, a transport velocity of at least one of the first and the second sheet is varied in step C using the breaking mechanism. Spoken differently, a specific transport velocity of at least one sheet for each pair of stacked sheets may be guaranteed at the reception location. For example, the breaking mechanism may also guarantee that the sheets are stopped (velocity=0 m/s). Therefore, the sheets will be reliably aligned to each other at the reception location in terms of their transport velocities.

As another option, the transport velocity of at least one of the first and the second sheet is varied such by using the breaking mechanism that the first and second sheet have the same transport velocity as soon as the first and the second sheet reach the reception location in register with each other. For example, one sheet may be stopped such that the sheet “waits” at the breaking mechanism until the second sheet arrives. Therefore, the breaking mechanism provides a very efficient measure to adapt the relative alignment of the sheets with respect to each other along the passageway used for transporting the sheets.

Preferably, the breaking mechanism comprises at least one abutting surface, and the first sheet to be fed is slowed down as soon as it contacts the at least one abutting surface. Using an abutting surface may advantageously provide the option to avoid any mechanism used to interact with the sheet's surfaces. Therefore, irregularities on the sheet surfaces may be avoided. In particular, the abutting surface of the breaking mechanism may interact with a side surface of the respective sheet.

Optionally, the breaking mechanism at least partially engages a passageway in step C provided by the conveyor mechanism for the sheets to be fed and the breaking mechanism is released by removing the breaking mechanism from the passageway. In other words, the breaking mechanism extends into the passageway when it is activated. When being deactivated, the breaking mechanism may be retracted from the passageway. Since the breaking mechanism extends into the passageway, it may be reliably guaranteed that the sheet interacts with the breaking mechanism and is appropriately aligned due to this contact.

In some embodiments, the alignment device comprises a first conveyor mechanism and a second conveyor mechanism. The first conveyor mechanism is configured for transporting the first sheet to be fed according to a first transportation route towards the reception location at a first transport velocity in step C. The second conveyor mechanism is configured for transporting the second sheet to be fed according to a second transportation route towards the reception location at a second transport velocity in step C. The first transportation route and the second transportation route end adjacent to each other at the reception location in a stacked fashion. The first sheet and the second sheet are at least partially transported using the respective conveyor mechanism simultaneous to each other. By using different conveyor mechanism, in effect, different transportation routes may be established which assist in compensating the time difference caused by the different points in time when the first and second sheet are separated from the plurality of sheets. However, the transportation routes may end at a combined same end location, such as the reception location. The different transport velocities are adjusted to each other such that the sheets are in register with each other at the reception location although the transportation routes are different.

Preferably, at least one accelerator mechanism is provided in step C to adjust at least one of the first and the second transport velocity such that the first sheet and the second sheet reach the reception location simultaneously and in register with each other in a stacked fashion. Therefore, the transport velocities may be adjusted to each other even while the sheets are actually being transported along the different transportation routes.

Optionally, the adjustment of the transport velocities is based on a relative distance between the sheets when being transported along the different transportation routes. For example, a sensor device may be used to acquire information on the relative distance between the sheets.

More preferably, the at least one accelerator mechanism comprises at least one accelerator roller or at least one pair of accelerator rollers. Accelerator rollers are very efficient in adapting the speed of a treated sheet which passes the respective rollers, in particular since the sheets are quasi-two-dimensional products.

Optionally, at least one feeder flap is used in step C to selectively route a respective sheet to be fed towards the first or the second conveyor mechanism. A feeder flap may be rotatable such that a front edge of the feeder flap may route a sheet along different transportation routes. However, feeder flaps avoid unwanted irregularities to be caused within the sheet surfaces while handling the sheets. Moreover, the feeder flap may also guarantee a specific alignment of the plurality of sheets of which the respective sheets are separated.

Preferably, the plurality of sheets to be fed are provided as a pile of sheets at an introduction station of the die cutting machine. Piles of sheets are easy to be provided and serve the purpose of such sheet-fed processing machines which are commonly used to produce a high number of same products, such as packaging.

The pile of sheets may be aligned such that the topmost sheet is provided at a same height independent of the number of remaining sheets within the pile. Accordingly, the point of interaction with a lifting device may always be same independent of the pile height.

In some embodiments, step B is carried out not before the first sheet to be fed is separated from the plurality of sheets provided as a pile of sheets at the introduction station. Accordingly, unwanted interactions during the lifting processes of the different sheets may be avoided.

Optionally, the respective first or second sheet is separated from the plurality of sheets using a suction process in steps A and B, respectively. Spoken differently, each lifting device may comprise a suction device. The suction device may interact efficiently with a top surface of the respective sheet without causing any irregularity therein.

Preferably, no more than the first and the second sheet are aligned to each other in step C. Therefore, it may be avoided that a middle sheet being placed between two adjacent outer sheets cannot be directly treated. Spoken differently, such a middle sheet could only be indirectly treated and aligned. Therefore, the alignment of the middle sheet cannot be guaranteed with similar confidence as this can be achieved for outer sheets. Thus, by limiting the number of sheets in the package to two, a high confidence of the alignment can be guaranteed.

Optionally, the method as described herein before is carried out computer-implemented. For example, a data processing device of a control device having circuitry may be configured to provide commands such that the before mentioned aspects of the method are carried out by respective devices coupled to the control device. In particular, the control device may be coupled to lifting devices, an alignment mechanism, a gripper bar and the cutting device.

Optionally, the control device may also be coupled to additional auxiliary devices, such as a conveyor mechanism.

According to another aspect, a die cutting machine is provided. The die cutting machine comprises a platen press with a cutting device, at least a lifting device, an alignment device, a gripper bar, and a control device. The control device is at least coupled to the lifting device, the alignment device, the gripper bar, and the cutting device. The control device is configured to carry out the method as described herein above. Therefore, a platen press as well as a die cutting machine with improved production rates are provided.

Optionally, the lifting device comprises at least one suction device. Accordingly, the sheets may be reliably treated by an interaction with their surface.

Preferably, the alignment device comprises a breaking mechanism. The breaking mechanism comprises a retractable abutting surface. The breaking mechanism may define an obstacle configured to appropriately adapt the transport velocity of the sheets.

All features and embodiments disclosed with respect to any aspect of the present disclosure are combinable alone or in (sub-)combination with any one of the remaining aspects of the present disclosure including each of the preferred embodiments thereof, provided the resulting combination of features is reasonable to a person skilled in the art.

### DESCRIPTION OF THE DRAWINGS

The forgoing aspects and further advantages of the claimed subject matter will become more readily appreciated as the same become better understood by reference to the following detailed description when taken in conjunction with the accompanying drawings. In the drawings,

FIG. 1 is a schematic drawing of a die cutting machine according to an embodiment of the invention,

FIG. 2 is a schematic drawing of part of the die cutting machine according to an embodiment of the invention,

FIG. 3 is a schematic drawing of a method of handling sheets by a die cutting machine according to an embodiment of the invention,

FIG. 4 is a schematic drawing of a part of the die cutting machine including an alignment device according to a first embodiment of the invention,

FIG. 5 is a schematic drawing of a part of the die cutting machine including an alignment device according to the first embodiment of the invention,

FIG. 6 is a schematic drawing of a part of the die cutting machine including an alignment device according to the first embodiment of the invention,

FIG. 7 is a schematic drawing of a part of the die cutting machine including an alignment device according to a second embodiment of the invention,

FIG. 8 is a schematic drawing of a part of the die cutting machine including an alignment device according to the second embodiment of the invention,

FIG. 9 is a schematic drawing of a part of the die cutting machine including an alignment device according to the second embodiment of the invention,

FIG. 10 is a schematic drawing of a part of the die cutting machine including an alignment device according to a third embodiment of the invention,

FIG. 11 is a schematic drawing of a part of the die cutting machine including an alignment device according to the third embodiment of the invention, and

FIG. 12 is a schematic drawing of a part of the die cutting machine including an alignment device according to the third embodiment of the invention.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

All of the features disclosed hereinafter with respect to the example embodiments and/or the accompanying figures can alone or in any sub-combination be combined with features of the aspects of the present disclosure including features of preferred embodiments thereof, provided the resulting feature combination is reasonable to a person skilled in the art.

For the purposes of the present disclosure, the phrase “at least one of A, B, and C”, for example, means (A), (B), (C), (A and B), (A and C), (B and C), or (A, B, and C), including all further possible permutations when greater than three elements are listed. In other words, the term “at least one of A and B” generally means “A and/or B”, namely “A” alone, “B” alone or “A and B”.

FIG. 1 is a schematic drawing of a die cutting machine 10 according to an embodiment of the invention.

The die cutting machine 10 is used to handle sheets 12A, 12B. For example, the die cutting machine 10 comprises a platen press 14 which is usable to cut the sheets 12A, 12B. The sheets 12A, 12B are introduced into the die cutting machine 10 at an introduction station 16 where the sheets 12A, 12B are provided by operators.

At the reception location 18, the sheets 12A, 12B are captured using a chain drive 20 which comprises gripper bars 22. Each gripper bar 22 is configured to capture a number of sheets 12A, 12B such that these can be transported through the die cutting machine 10 along the chain drive 20.

After the sheets 12A, 12B have been cut at the platen press 14, the waste resulting of the cutting operation is ejected at the waste ejection station 24. Subsequently, the blanks of the processed sheets 12A, 12B are collected as a pile of blanks 28 at the blanking station 26 which represents an output of the processing procedure underlying the die cutting machine 10.

At the ejection station 29 the pile of blanks may be removed from the die cutting machine 10 for further usage.

Therefore, starting from a pile 30 of “unprocessed” sheets 12A, 12B provided at the introduction station 16 a pile of blanks 28 is achieved and received at the ejection station 29.

In contrast to prior art die cutting machines, the die cutting machine 10 according to the present invention is configured to process two sheets 12A, 12B simultaneously, at least from the platen press 14 on. Thereby, an improved production rate is achieved. To this end, the die cutting machine 10 comprises a control device 32. The control device 32 is at least coupled to the platen press 14, the introduction station 16, and the gripper bars 22.

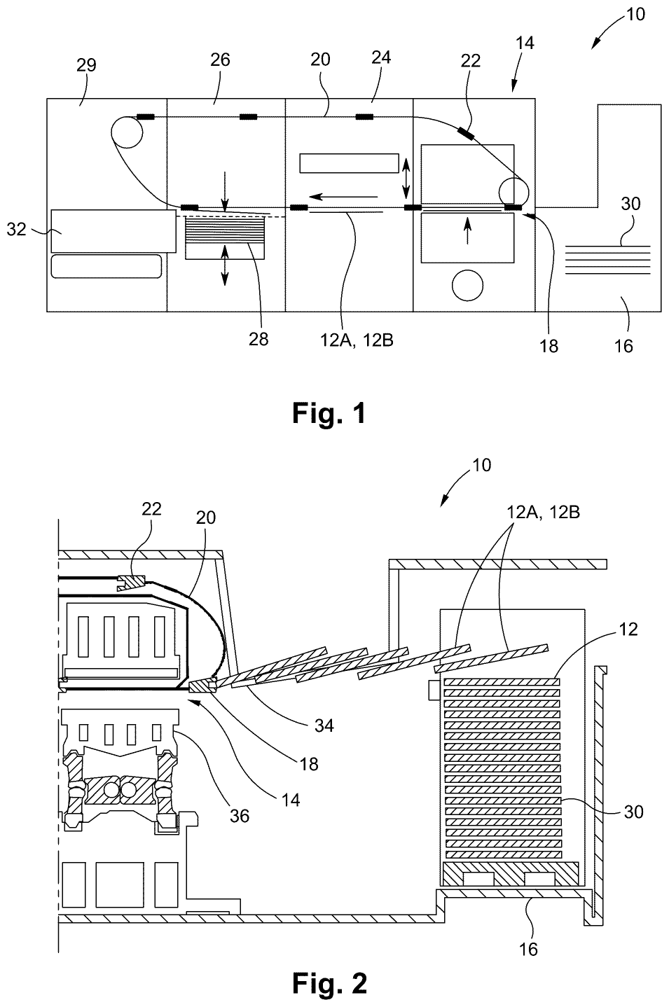

FIG. 2 is a schematic drawing of part of the die cutting machine 10 according to an embodiment of the invention.

The pile 30 of sheets 12 is provided at the introduction station 16 and aligned by a height control mechanism such that the topmost sheet 12 is provided at a same height independent from the number of sheets 12 left within the pile 30.

The sheets 12 are individually caught and provided to a feeder table 34 nearby the reception location 18. At the reception location 18, the sheets 12 are captured by a gripper bar 22 of the chain drive. Here, the die cutting machine 10 is shown in a configuration where yet only a first sheet 12A reached the reception location 18. Accordingly, a second sheet 12B is moving towards the reception location 18. The gripper bar 22 is waiting for the second sheet 12B to arrive such that the sheets 12A, 12B are aligned to each other such that they are in register with each other in a stacked fashion and that both sheets 12A, 12B can be simultaneously caught in the stacked fashion. Subsequently, the platen 36 of the platen press 14 may be used to cut the stacked sheets 12A, 12B simultaneously in a single cutting operation.

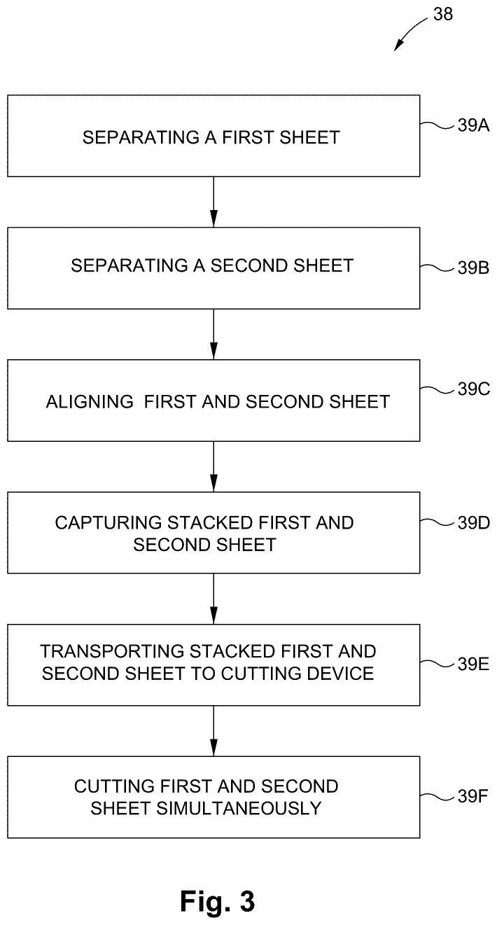

FIG. 3 is a schematic drawing of a method 38 of handling sheets 12 by a die cutting machine 10 according to an embodiment of the invention.

In step 39A, a first sheet 12 to be fed to the platen press 14 is separated from a pile 30 of sheets 12 to be fed using a lifting device 42.

In step 39B, a second sheet 12 to be fed to the platen press 14 is separated from the pile 30 of sheets 12 to be fed using a lifting device 42.

Steps 39A, 39B are particularly carried out at the introduction station 16 of the die cutting machine 10. Here step 39B is not carried out before step 39A is finished. In other words, the two sheets 12A, 12B are individually separated from the pile 30.

Subsequently, the first and the second sheet 12 to be fed to the platen press 14 are aligned such that they reach a reception location 18 simultaneously and in register with each other in a stacked fashion using an alignment device 44 in step 39C.

Then, the stacked first and second sheet 12A, 12B to be fed are captured using a gripper bar 22 at the reception location 18 at step 39D. The alignment procedure offers the possibility to treat the sheets 12A, 12B together from the reception location 18 on.

In step 39E, the stacked first and second sheet 12A, 12B are transported to a cutting device of the platen press 14 using the at least one gripper bar 22.

Subsequently, the stacked first and second sheet 12A, 12B are simultaneously cut using the cutting device in a single cutting operation in step 39F.

Consequently, the method 38 provides an improved production rate since the underlying alignment of the sheets 12A, 12B enables simultaneous cutting operations.

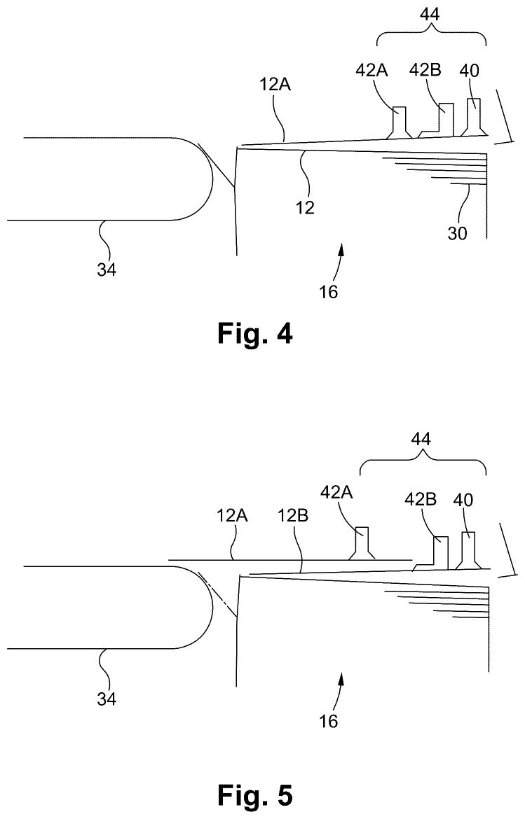

FIG. 4 is a schematic drawing of a part of the die cutting machine 10 including an alignment device 44 according to a first embodiment of the invention.

In this embodiment, the sheets 12 are separated from the pile 30 using a lifting device 40 at the introduction station 16. Then, the respective separated sheet 12A is transferred to a first transporting device 42A.

Subsequently, the next sheet 12B is separated from the pile 30 using the lifting device 40 and transferred to another transporting device 42B, which can be best seen in FIG. 5.

The alignment device 44 comprises the lifting device 40 and the transporting devices 42A, 42B. However, the lifting device 40 is not required to be separate from the transporting devices 42A, 42B. The transporting devices 42A, 42B could also individually include the functionality of the lifting device 40.

Moreover, according to this embodiment, the lifting device 40 and the transporting devices 42A, 42B include suction functionalities. This means that the respective sheets 12 may be caught by low pressure established between a surface of the sheet 12 and the respective device. Hence, the surface of the sheet 12 may be prevented from irregularities which can be possibly caused by other capturing techniques.

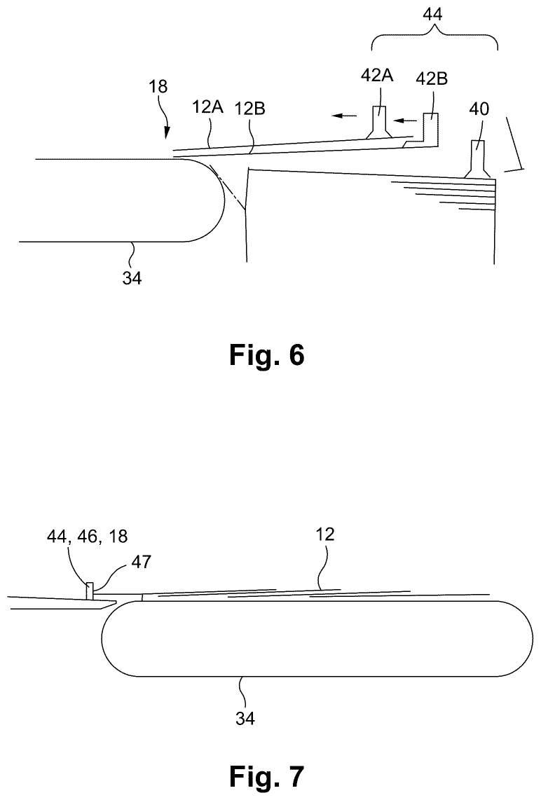

As can be seen in FIG. 5, the different transporting devices 42A, 42B move at different transport velocities. FIG. 6 shows that the transport velocities of the different transporting devices 42A, 42B are aligned to each other such that the first sheet 12a and the second sheet 12B reach the reception location 18 in register with each other in a stacked fashion. That means that the time period caused by the different points in time when the respective sheets 12A, 12B are separated from the pile 30 can be compensated as the second transporting device 42B moves faster. However, during the transport procedure towards the reception location 18 the transport velocities are varied such that the velocities of the individual sheets 12A, 12B are same when reaching the reception location 18. Therefore, aligned simultaneous movement beyond the reception location 18 is guaranteed.

FIG. 7 is a schematic drawing of a part of the die cutting machine 10 including an alignment device 44 according to a second embodiment of the invention. It is noted that the peculiarities of the second embodiment are combinable with those of the first embodiment.

Here, the alignment device 44 comprises a breaking mechanism 46 having an abutting surface 47. The breaking mechanism 46 is provided within the passageway of the sheets 12 at the reception location 18. Using the feeder table 34 the sheets 12 are transported towards the reception location 18. When contacting the abutting surface 47, the sheets 12 are stopped if the breaking mechanism 46 is activated.

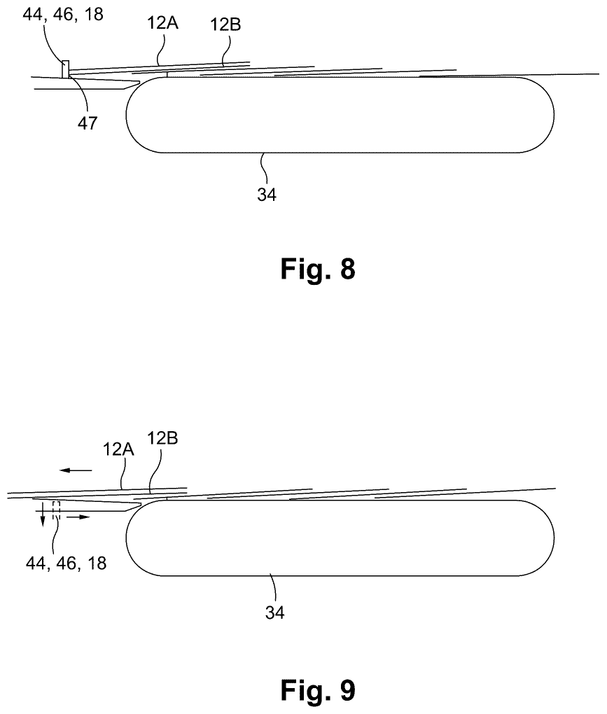

FIG. 8 shows that the breaking mechanism 46 is used to align two sheets 12A, 12B with respect to each other such that they are in register with each other in a stacked fashion at the reception location 18.

Although the breaking mechanism 46 is stationary in place regarding its relative position along the passageway of the sheets 12 in the present embodiment, this may also be different in other embodiments. For example, the breaking mechanism may move along the passageway with a velocity less than the transport velocities of the first sheet 12A and the second sheet 12B.

When both sheets 12A, 12B are aligned with respect to each other at the reception location 18, the breaking mechanism 46 is deactivated as shown in FIG. 9. To this end, the breaking mechanism 46 is removed from the passageway such that the passageway is released for the stacked sheets 12A, 12B. Subsequently, the stacked sheets 12A, 12B may be treated as a package for further processing in the die cutting machine 10.

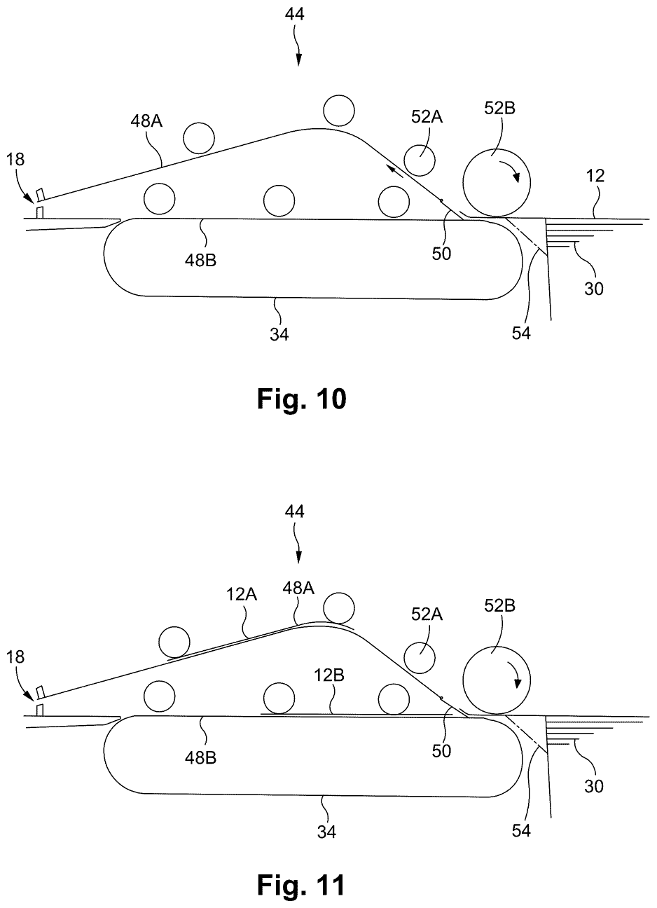

FIG. 10 is a schematic drawing of a part of the die cutting machine 10 including an alignment device 44 according to a third embodiment of the invention. It is noted that the peculiarities of the third embodiment are combinable with those of the second embodiment.

In this case, the alignment device 44 comprises a first conveyor mechanism 48A which is configured to transport a respective sheet 12 towards the reception location 18 along a first transportation route. Moreover, the alignment device 44 also comprises a second conveyor mechanism 48B which is configured to transport the respective sheet 12 towards the reception location 18 along a second transportation route which is different from the first transportation route. Since the different transportation routes have different lengths, thereby a possibility is provided to compensate the time difference caused by the different lifting times of the separate sheets 12A, 12B from the pile 30.

For introducing a sheet 12 along a specific transportation route, the alignment device 44 also comprises a feeder flap 50. By actuating the rotatable feeder flap a sheet 12 is routed along different paths.

Moreover, the alignment device 44 also comprises various accelerator rollers 52A, 52B which can be used to adjust the velocity of a sheet 12 along the transportation routes.

Optionally the feeder flap 50 comprises or may be combined with a feeder device 54 provided next to the pile 30. Then, the feeder flap 50 may also have the functionality of the feeder device 54 which ensures a straight (vertical) alignment of the remaining sheets 12 of the pile 30 although sheets are separated thereof.

In particular, FIG. 11 shows that the feeder flap 50 and the accelerator rollers 52A, 52B are used such that the first sheet 12A is routed along the transportation route having a greater length. Thereby, the head start of the first sheet 12A can be compensated since the transportation route which the second sheet 12B has to pass is shorter.

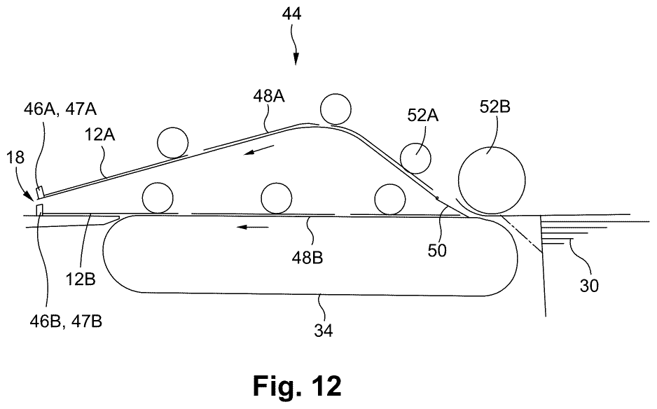

In effect, FIG. 12 shows that both sheets 12A, 12B reach the reception location 18 simultaneously. Since the various transportation routes have respective ends which are positioned on top of one another, the sheets 12A, 12B reach the reception location in register with each other in a stacked fashion.

The alignment is assisted since each transportation route comprises a respective breaking mechanism 46A, 46B in the present embodiment. The quality of the alignment of the first and second sheet 12A, 12B can, thus, even be further improved.

Therefore, the alignment device 44 ensures that two sheets 12A, 12B are provided at the reception location 18 such that they are in register with each other in a stacked fashion.

Downstream the reception location 18, the sheets 12A, 12B may be treated as a package, collectively captured by a gripper bar 22 (step 39D), simultaneously being transported to the cutting device (step 39E), and being cut together in a single cutting operation (step 39F).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about”, “approximately”, “near” etc., mean plus or minus 5% of the stated value.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

1. A method for handling sheets by a die cutting machine having a platen press, the method comprising at least the steps of:
A) separating, using a lifting device, a first sheet to be fed to the platen press from a plurality of sheets to be fed,
B) separating, using a lifting device, a second sheet to be fed to the platen press from the plurality of sheets to be fed,
C) aligning, using an alignment device, the first and the second sheet to be fed to the platen press such that they reach a reception location simultaneously and in register with each other in a stacked fashion,
D) capturing, using at least one gripper bar, the stacked first and second sheet to be fed at the reception location,
E) transporting, using the at least one gripper bar, the stacked first and second sheet to a cutting device of the platen press, and
F) cutting, using the cutting device, the stacked first and second sheet simultaneously in a single cutting operation.

2. The method according to claim 1, wherein cut blanks are separated from the stacked first and second sheet simultaneously in a single separating operation subsequent to step F).

3. The method according to claim 1, wherein the first sheet to be fed is transported towards the reception location using a first transport velocity in step C), wherein the second sheet to be fed is transported towards the reception location using a second transport velocity in step C), and wherein the first and the second transport velocities are adjusted to each other such that the first and the second sheet to be fed reach the reception location simultaneously and in register with each other in a stacked fashion.

4. The method according to claim 3, wherein the first and second transport velocities are varied during a transport procedure of the first and second sheet towards the reception location in step C), and wherein the first and second transport velocities are adjusted to each other such that they are same when the first and the second sheet to be fed reach the reception location.

5. The method according to claim 1, wherein in step C) the first and the second sheet to be fed are carried using a lifting device until they are aligned to each other.

6. The method according to claim 1, wherein the first and second sheet to be fed are carried using a conveyor mechanism in step C), wherein a breaking mechanism is provided at the reception location, and wherein the breaking mechanism is released as soon as the first and the second sheet reach the breaking mechanism in register with each other in a stacked fashion.

7. The method according to claim 6, wherein the first and the second sheet are carried in an at least partially stacked fashion towards the reception location in step C).

8. The method according to claim 6, wherein, using the breaking mechanism, a transport velocity of at least one of the first and the second sheet is varied in step C).

9. The method according to claim 8, wherein, using the breaking mechanism, the transport velocity of at least one of the first and the second sheet is varied such that the first and second sheet have the same transport velocity as soon as the first and the second sheet reach the reception location in register with each other.

10. The method according to claim 6, wherein the breaking mechanism comprises at least one abutting surface, and wherein the first sheet to be fed is slowed down as soon as it contacts the at least one abutting surface.

11. The method according to claim 6, wherein in step C) the breaking mechanism at least partially engages a passageway provided by the conveyor mechanism for the sheets to be fed, and wherein the breaking mechanism is released by removing the breaking mechanism from the passageway.

12. The method according to claim 1,
wherein the alignment device comprises a first conveyor mechanism and a second conveyor mechanism,
wherein the first conveyor mechanism is configured for transporting the first sheet to be fed according to a first transportation route towards the reception location at a first transport velocity in step C),
wherein the second conveyor mechanism is configured for transporting the second sheet to be fed according to a second transportation route towards the reception location at a second transport velocity in step C),
wherein the first transportation route and the second transportation route end adjacent to each other at the reception location in a stacked fashion, and
wherein the first sheet and the second sheet are at least partially transported using the respective conveyor mechanism simultaneous to each other.

13. The method according to claim 12, wherein at least one accelerator mechanism is provided in step C) to adjust at least one of the first and the second transport velocity such that the first sheet and the second sheet reach the reception location simultaneously and in register with each other in a stacked fashion.

14. The method according to claim 12, wherein in step C) at least one feeder flap is used to selectively route a respective sheet to be fed towards the first or the second conveyor mechanism.

15. A die cutting machine comprising at least a platen press with a cutting device, a lifting device, an alignment device, a gripper bar, and a control device, wherein the control device is at least coupled to the lifting device, the alignment device, the cutting device, and the gripper bar, and characterized in that the control device is configured to carry out the method according to claim 1.
